(19) United States
(12) Patent Application Publication
(10) Pub. No.: US 2012/0251105 A1
(43) Pub. Date: Oct. 4, 2012

(54) METHOD AND APPARATUS FOR PROVIDING A LINE OF SPOTS LAUNCH OF LIGHT INTO AN END OF A MULTIMODE OPTICAL FIBER

(75) Inventors: Chi Hang Kwok, Tsing Yi.N.T. (HK); Ian Hugh White, Cambridge (GB); Richard Vincent Penty, Cambridge (GB); David George Cunningham, Woodbridge Suffolk (GB)

(73) Assignee: CAMBRIDGE ENTERPRISE LIMITED, Cambridge (GB)

(21) Appl. No.: 13/516,593

(22) PCT Filed: Mar. 19, 2010
(86) PCT No.: PCT/IB10/00839

§ 371 Date: Jun. 15, 2012

Related U.S. Application Data
(60) Provisional application No. 61/286,980, filed on Dec. 16, 2009.

(51) Int. Cl. H04B 10/13; H04J 14/04; G02B 6/36; H04B 10/04

(52) U.S. Cl. 398/44; 398/200; 398/139; 398/143; 385/88

(57) ABSTRACT

A method and an apparatus are provided for launching light into an entrance facet of a MMF of an optical MMF link in a way that excites one or more targeted higher-order mode groups in the MMF. The light is launched into the entrance facet of the MMF as a line of phase-modulated spots, referred to herein as a “line launch”. The line launch causes one or more targeted higher-order mode groups to be excited in the MMF. The use of the line launch to excite one or more higher-order mode groups in the MMF increases the bandwidth of the link and allows overall link lengths to be increased. In addition, the use of the line launch is reliable and robust despite defects in the MMF and despite connector offsets. Thus, the use of the line launch ensures that a sufficient increase in link bandwidth will be achieved despite the existence of defects in the MMF and even if there is some amount of optical misalignment due to the connector being offset relative to the corresponding receptacle.

### CROSS-REFERENCE TO RELATED APPLICATIONS

This application is a continuation-in-part of, and claims the benefit of the filing date of, provisional application Ser. No. 61/286,980, which was filed in the United State Patent and Trademark Office on Dec. 16, 2009, entitled “METHOD AND APPARATUS FOR PROVIDING A LINE OF SPOTS LAUNCH OF LIGHT INTO AN END OF A MULTIMODE OPTICAL FIBER”, which is hereby incorporated in its entirety.

### TECHNICAL FIELD OF THE INVENTION

The invention relates to optical multimode fiber (MMF) communications links over which data in the form of optical signals is transmitted and received over MMFs. More particularly, the invention relates to methods and apparatuses for improving the channel capacity of optical MMF links.

### BACKGROUND OF THE INVENTION

In optical MMF links, optical transceivers are used to transmit and receive optical signals over optical MMFs. An optical transceiver generates amplitude and/or phase and/or polarization modulated optical signals that represent data, which are then transmitted over an optical MMF coupled to the transceiver. Each optical transceiver includes a transmitter side and a receiver side. On the transmitter side of the optical transceiver, a laser light source generates the optical data signals based on a received electrical data signal and an optical coupling system optically couples, or images, the light onto an end facet of an optical fiber. The laser light source typically is made up of one or more laser diodes that generate light of a particular wavelength or wavelength range. The optical coupling system typically includes one or more reflective, refractive and/or diffractive elements. On the receiver side of the optical transceiver, a photodiode detects an optical data signal transmitted over an MMF and converts the optical data signal into an electrical data signal, which is then amplified and processed by electrical circuitry of the receiver side to recover the data.

The majority of the optical fibers that have been installed within buildings are MMFs. MMFs were originally designed for use with light emitting diodes (LEDs) as the light sources. Prior to single mode optical fibers being widely deployed for use in high bit rate, long distance links, a demand for increased channel capacity led to much work being carried out between the late 1970 s and the early 1980 s to improve the performance of optical MMF links. Although much of the development work has ceased, MMFs continue to be used in optical links that operate at lower bit rates and over shorter distances. For example, in building or local area networks, a large installed base of MMFs exist, which represents a significant investment.

In recent years, the demand for high data rate (e.g., 10 Gigabits per second (Gb/s) and higher) local area networks has increased dramatically. Thus, even though an MMF may only be utilised over short distances (e.g., 500 meters (m)), the required data rates cannot be achieved by utilising conventional techniques. In such links, certain link performance characteristics, such as the link transmission distance, for example, are dependent in part on the design of the optical coupling system, the modal bandwidth of the fiber, and the relative intensity noise (RIN) of the laser diode. The modal bandwidth of the fiber and the RIN of the laser diode can be affected by the launch conditions of the laser light into the end of the MMF. The launch conditions are, in turn, dependent upon the properties of the laser diode itself and upon the design and configuration of the optical coupling system. Due to limitations on the manufacturability of optical elements that are typically used in optical coupling systems, the ability to control the launch conditions is limited primarily to designing and configuring the optical coupling system to control the manner in which it optically couples the light from the laser diode onto the entrance facet of the MMF.

Launch techniques such as Center Launch (CL) techniques, Offset Launch (OSL) techniques, or a combination the two, called dual launch (DL) techniques, are known to significantly increase the modal bandwidth of MMF links. For this reason, these launch techniques have been standardized for 10 Gigabit Ethernet links. However, at higher data rates, such as, for example, 40 Gb/s, these launch techniques do not create a sufficient increase in the modal bandwidth of an MMF optical link. Hence, a need exists for a new launch technique that provides MMF optical links with even higher modal bandwidths. One method that is sometimes used to provide an MMF optical link with an increased modal bandwidth is to excite only a small number of fiber mode groups in the MMF. For example, various attempts have been made to excite the lowest-order mode group in MMFs in order to increase the modal bandwidth of the link. However, such attempts generally use CL techniques, which do result in significant increases in modal bandwidth, but only if strict tolerance requirements are met. It has also been proposed to use mode filters in the receivers of the links to increase the modal bandwidth of the links, but mode filters often introduce excessive modal noise into the links.

In order to overcome some of these issues, launch techniques have been proposed that selectively excite one or more higher-order mode groups in an MMF of an optical link in order to increase the bandwidth of the MMF optical link. For example, it is well known that spiral launch techniques can be used to target higher-order mode groups in an MMF, and the use of such techniques have been proposed as part of the 10 GBASE-LRM standards process. Indeed, the use of spiral launch techniques remains a valid approach to increasing the bandwidth of an MMF optical link. Spiral launch techniques target the Laguerre Gaussian (LG) mode groups in the MMF and use a radial phase mask that is matched to a particular LG mode group of the MMF. However, there is reason to believe that spiral launch techniques may not provide significant tolerance to connector offsets. In other words, if the connector that connects the MMF to the receptacle of the optical transceiver is offset in any radial direction relative to the receptacle such that a degree of optical misalignment is introduced into the launch, a radial phase mismatch may exist between the phase of the LG mode group of the MMF that is being targeted and the phase of the light that is being launched into the entrance facet of the MMF. Due to this radial phase mismatch, the target LG mode group may not be sufficiently excited and/or other non-targeted LG mode groups of the MMF may be excited. The consequence of these unintended results may be a failure to sufficiently increase the modal bandwidth of the MMF optical link.

Launch techniques have also been proposed that excite Hermite Gaussian (HMG) mode groups in an MMF. For example, a number of known launch techniques have been proposed for exciting higher-order HMG mode groups, including, for example, techniques that (1) laterally offset the laser beam being launched into the entrance facet of an MMF, (2) angularly offsetting the laser beam being launched into the entrance facet of an MMF, or (3) use masks that match the amplitude and phase of the launched laser beam with the amplitude and phase of a targeted HMG mode group of the MMF. However, with all of the known launch techniques for exciting higher-order HMG mode groups, alignment is critical in that unintended misalignment between the launched light beam and the entrance facet of the MMF can produce undesired results. Consequently, the proposed launch techniques for exciting higher-order HMG mode groups in an MMF generally do not provide for greater connector offset tolerance. In addition, the task of manufacturing masks that match both amplitude and phase can be relatively difficult.

A need exists for a launch technique that is capable of exciting one or more higher-order mode groups of an MMF in order to increase the bandwidth of the MMF optical link. A need also exists for such a launch technique that provides the desired effect of increasing link bandwidth without increasing modal noise in the MMF optical link. A further need exists for such a launch technique that achieves these goals and, at the same time, that obviates the aforementioned problems associated with connector offsets.

### SUMMARY OF THE INVENTION

The invention is directed to an apparatus and method for providing a line launch of light into an entrance facet of an MMF of an optical communications link to cause at least one targeted HMG mode group of the MMF to be excited. The invention is also directed to an optical link in which the method and apparatus are implemented. The apparatus comprises a laser and an optics system. The laser produces laser light. The optics system receives the laser light. The optics system includes an HMG beam converter that converts the received laser light into a line of HMG spots, which, if launched into an entrance facet of an MMF, causes at least one targeted HMG mode group of the MMF to be excited. Excitation of the targeted HMG mode group causes the effective modal bandwidth of the MMF to be increased.

The method comprises the following: with a laser, producing laser light; in an optics system, receiving the laser light; with an HMG beam converter of the optics system, converting the received laser light into a line of HMG spots. The method further comprises, with an MMF that is optically coupled to the optics system, receiving the line of spots at an entrance facet of the MMF to cause at least one HMG mode group of the MMF to be selectively excited.

The method and apparatus may also be used in conjunction with an apparatus that performs a known center launch technique, in which case at least one higher-order HMG mode group and at least one lower order LG mode group are excited in the link MMF. A mode group demultiplexer (DeMux) is used to separate the higher-order HMG mode group(s) from the lower-order LG mode group(s), which are then coupled to respective optical receivers.

These and other features and advantages of the invention will become apparent from the following description, drawings and claims.

### BRIEF DESCRIPTION OF THE DRAWINGS

FIG. 1 illustrates a perspective view of a portion of an MMF having an entrance facet that is defined in terms of the x and y coordinates of a Cartesian Coordinate System and an optical axis defined in terms of the z coordinate of the Cartesian Coordinate System.

FIG. 2 illustrates a line of phase-coherent spots produced by the line launch of the present invention in accordance with an illustrative embodiment.

FIG. 3 illustrates a block diagram of an optical MMF link that incorporates the methods and apparatuses of the invention in accordance with an illustrative, or exemplary, embodiment for producing a line launch such as that shown in FIG. 2.

FIG. 4A illustrates a mode group power distribution for an ideal HMG line launch.

FIG. 4B illustrates a mode group power distribution for a non-ideal HMG line launch produced by a binary mask of the beam converter shown in FIG. 3.

FIGS. 5A-5D illustrate cross-sectional views of the HMG beam converter shown in FIG. 3, which demonstrates the fabrication steps for fabricating an HMG beam converter in accordance with an illustrative or exemplary embodiment.

FIGS. 6A and 6B illustrate frequency responses for two different MMFs, fiber A and fiber B, for three different launch techniques: (1) the known center launch technique; (2) the known offset launch technique; and (3) the line launch technique of the invention.

FIG. 7 illustrates a plan view of a multi-keyway optical fiber connector in accordance with an illustrative or exemplary embodiment.

FIG. 8 illustrates a plan view of the keyway component of a conventional, or standard, FC/PC square adapter.

FIG. 9 illustrates a plan view of the keyway component of the connector shown in FIG. 7.

FIG. 10 illustrates a block diagram of an optical link in accordance with another illustrative embodiment of the invention in which the line launch technique of the invention is used in combination with the aforementioned known center launch technique.

FIG. 11 illustrates a plan view of the mode group DeMux shown in FIG. 10.

### DETAILED DESCRIPTION OF AN ILLUSTRATIVE EMBODIMENT

The invention is directed to a method and an apparatus for launching light into an entrance facet of a MMF of an MMF optical link in a way that excites one or more targeted higher-order mode groups in the MMF. The light is launched into the entrance facet of the MMF as a line of phase-modulated spots. Because the light is launched into the entrance facet of the MMF as a line of multiple phase-modulated spots, the launch performed in accordance with the invention will be referred to hereinafter as a “line launch”. The line launch causes one or more targeted higher-order mode groups to be excited in the MMF. The use of the line launch to excite one or more higher-order mode groups in the MMF increases the bandwidth of the link and allows overall link lengths to be increased. In addition, the use of the line launch is reliable and robust despite defects in the MMF and despite connector offsets. Thus, the use of the line launch ensures that a sufficient increase in link bandwidth will be achieved despite the existence of defects in the MMF and even if there is some amount of optical misalignment due to the connector being offset relative to the corresponding receptacle.

In accordance with the illustrative, or exemplary, embodiments, the line launch targets one or more higher-order HMG mode groups. HMG mode groups are relatively insensitive to launch offsets that are orthogonal to their axes, which are generally coaxial with the optical axis of the MMF in which the HMG mode groups propagate. For this reason, using the line launch technique to selectively excite one or more higher-order HMG mode groups of an MMF increases the bandwidth of an MMF optical link, while, at the same time, providing at least some tolerance to connector offsets.

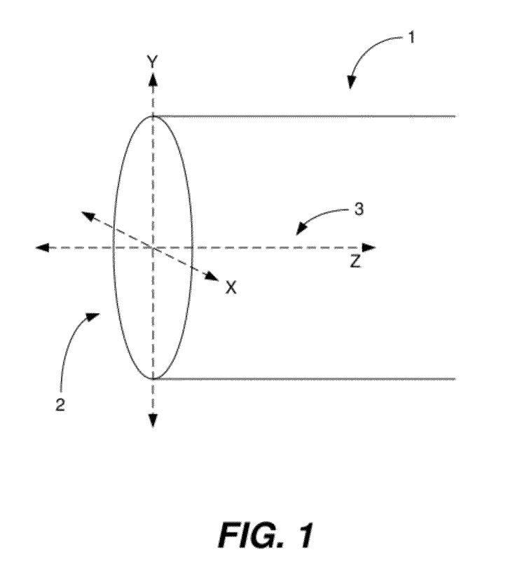

FIG. 1 illustrates a perspective view of a portion of an MMF 1 having an entrance facet 2 and an optical axis 3. The optical axis 3 of the MMF 1 corresponds to the z-axis of a Cartesian Coordinate System. Unlike LG mode groups, which are radially symmetric about the optical axis 3 of the MMF 1, HMG mode groups tend to be radially asymmetric about the optical axis 3 of the MMF 1. In other words, HMG mode groups exhibit behavioral differences in the horizontal (i.e., x) and vertical (i.e., y) dimensions, which are orthogonal to the optical axis 3 of the MMF 1. The phase of an HMG mode group corresponds to the x-dimension whereas the amplitude of an HMG mode group corresponds to the y-dimension. The x- and y-dimensions correspond to the x-axis and the y-axis, respectively, of the Cartesian Coordinate System, which are co-planar with each other and orthogonal to the z-axis of the Cartesian Coordinate System.

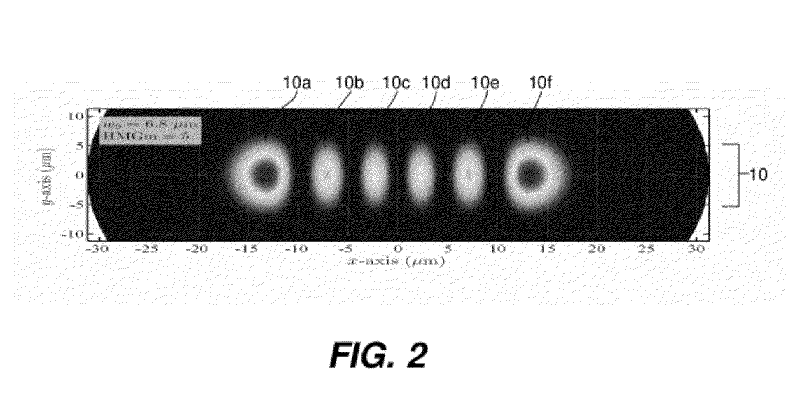

FIG. 2 illustrates a two-dimensional contour plot of the optical intensity of a line launch comprising a line 10 of phase-modulated spots 10a-10f. The horizontal axis of the contour plot shown in FIG. 2 corresponds to the x-axis of the MMF 1 shown in FIG. 1. The vertical axis of the contour plot shown in FIG. 2 corresponds to the y-axis of the MMF 1 shown in FIG. 1. The numerical values on the x- and y-axes of the contour plot are given in micrometers (μm). In accordance with this embodiment, the line launch targets HMG mode group 5 and comprises. The invention is not limited, however, to exciting any particular higher-order mode group. By exciting only a particular targeted higher-order mode group, such as mode group 5, for example, mode groups other than the targeted mode group are suppressed, thereby preventing the light beam from broadening due to modal dispersion. This, in turn, increases the transmission bandwidth of the optical MMF link.

The operation of the line launch is best understood using a mode theory for an MMF. The basic mode calculation will therefore now be described and used to develop a solution for the line launch. In solving the scalar wave equation for the guided spatial modes in MMFs, a set of mathematical expressions are developed for the launch transverse electric field that enables a distinct excitation of a particular mode group to occur. The properties of light propagation along an MMF are determined by its core diameter as well as its refractive index profile. For the initial calculations, it is assumed that the refractive index profile of a typical graded-index MMF can be generalized as a power-law function:

$$n ( r ) = \{ \begin{matrix}{n}_{1} \sqrt{1 - 2 {Δ ( \frac{r}{a} )}^{α}} & for r < a \\ {n}_{2} & for r \geq a\end{matrix} \qquad Eq . ( 1 )$$

where n₁ is the axial refractive index at the core centre, r is the radial distance from the core centre, a is the core radius, α is the alpha profile parameter, and Δ=(n₁²−n₂²)/2n₁² is the relative refractive index difference between core and cladding for a cladding refractive index n₂. An infinite alpha profile parameter α≈∞ gives a step refractive index profile; whereas α≈2 is typically used for graded-index MMFs. For the analysis of graded-index MMFs, the Helmholtz wave equation in polar coordinate is used:

$${∇}^{2} Ψ ( r , θ , z ) + {{( \frac{2 π}{λ} )}^{2} [ n ( r ) ]}^{2} Ψ ( r , θ , z ) = 0 \qquad Eq . ( 2 )$$

where ∇² is the Laplacian operator.

The propagation of signal at carrier frequency ω₀ along the z-axis in an MMF is the superposition of multiple time-harmonic, electric-field plane waves of mode (μ, ν), described by the following phasor notation expression

E(r, θ, z, t)Σê_{μν}E(t)ψ_{μ}(r)exp(iνθ)exp[i(ω₀t−β_{μν}z)] Eq. (3)

where ê_{μν}, is the unit vector in the direction of the electric field, E(t) is the signal envelope, ψ_{μ}(r) is the unitless normalized transverse profile in a radial order μ, and β_{μν} is propagation constant. The constituent plane waves that define E(r, θ, z, t) are uniquely defined by β_{μν} and a corresponding orthonormal basis set ψ_{μ}(r)exp(iνθ) which has an oscillatory behavior within the fiber core in an azimuthal order ν. By expending the Laplacian operator with the Fourier decomposited optical field in polar coordinate, the Helmholtz wave equation can be simplified to a scalar wave equation when the time-varying envelope E_{μ}(t) is small compared with the carrier frequency ω₀ [20],

$$\frac{1}{r} \frac{d}{d r} [ r \frac{d {ψ}_{μ} ( r )}{d r} ] + \{ {[ n ( r ) ]}^{2} - {β}_{μ v}^{2} - \frac{{v}^{2}}{{r}^{2}} \} {ψ}_{μ} ( r ) = 0 \qquad ( 4 )$$

For signal modulation at a rate smaller than 100 Gb/s, the signal envelope E_{μ}(t) varies at least four orders of magnitude slower than the carrier frequency ω₀ in the near infrared regime. Hence, the slowly varying approximation holds in arriving at Eq. (4). Modern graded-index MMFs used for data communication applications are approximately square law media in which the optimum refractive index profile for minimal mode dispersion is α≈2. However the actual value typically ranges between 1.8 and 2.2 depending on the material and the optimized operating wavelength. When the relative refractive index difference is small Δ<<1, the mode field distribution can be modeled, to at least a first approximation, as the field distribution of the modes of a square law medium (α=2) which can be solved analytically. For a square law medium, the scale wave equation can be written as [21]

$$\frac{{d}^{2} f}{d {ζ}^{2}} + [ - \frac{1}{4} + \frac{{( {k}_{0} {n}_{1} )}^{2} - {β}^{2}}{( {k}_{0} {n}_{1} ) \sqrt{2 Δ}} \frac{1}{4 x} - \frac{{v}^{2} - 1}{4 {x}^{2}} ] f = 0 \\ where f ( r ) = {κ}^{\frac{1}{4}} r ψ ( r ) , ζ = κ {r}^{2} , and κ = {k}_{0} {n}_{1} \sqrt{2 Δ} / a . \qquad Eq . ( 5 )$$

Eq. (5) is in the form of Whittaker's equation. The only solution to this equation for which ψ_{μ}(0) is finite can be expressed as a confluent hypergeometric function [21,22] which is bounded as r→∞ when

$$\frac{a}{{k}_{0} {n}_{1} \sqrt{2 Δ}} [ {( {k}_{0} {n}_{1} )}^{2} - {β}_{μ v}^{2} ] = 2 ( 2 μ + v + 1 ) \qquad Eq . ( 6 )$$

Hence, the exact solutions to the wave equation can be written in a form of the associated Laguerre function L_{μ}^{(ν)}(x) as

$${ψ}_{μ v} ( r , θ ) = {κ}^{\frac{2 v - 1}{4}} {r}^{v} exp ( - \frac{κ {r}^{2}}{2} ) {L}_{μ}^{( v )} ( κ {r}^{2} ) exp ( i v θ ) \qquad Eq . ( 7 )$$

where the associated Laguerre polynomials L_{μ}^{(ν)}(x) are defined as

$${L}_{μ}^{( v )} ( x ) = {\sum }_{k = 0}^{μ} {( - 1 )}^{k} \frac{( μ + v ) !}{( μ - k ) ! ( v + k ) !} \frac{{x}^{k}}{k !} \qquad Eq . ( 8 )$$

For α≈2 and Δ<<1, linearly polarized modes may be used, where the transverse fields are represented to a good approximation by Laguerre-Gaussian functions. The associated Laguerre polynomial function in Eq. (8) in polar coordinate may be expressed in terms of Hermite polynomial in Cartesian coordinate using x=r cos θ and y=r sin θ [23]

$${L}_{μ}^{( v )} ( {r}^{2} ) = \frac{{( - 1 )}^{μ}}{{2}^{2 μ} μ !} {\sum }_{k = 0}^{μ} \frac{μ !}{k ! ( μ - k ) !} {H}_{2 k} ( r cos θ ) {H}_{2 ( μ - k )} ( r sin θ ) \qquad Eq . ( 9 )$$

from which the Hermite polynomials Hₘ(x) to be used in our discussion are defined as

$$\begin{matrix}{H}_{m} ( x ) = {( - 1 )}^{m} exp ( {x}^{2} ) \frac{{d}^{m}}{d {x}^{m}} [ exp ( - {x}^{2} ) ] \\ = m ! {\sum }_{k = 0}^{⌊ m / 2 ⌋} {( - 1 )}^{k} \frac{{( 2 x )}^{m - 2 k}}{k ! ( m - 2 k ) !}\end{matrix} \qquad Eq . ( 10 )$$

where m is the order of the Hermite polynomial and x is the displacement. The expression └.┘ in Eq. (10) rounds the value to the nearest integers less than or equal to itself.

The modal excitation from a given launch field to a multimode fiber is determined by calculating the power coupling into each fiber mode through the overlap integral of the electric fields of the incident beam Eᵢₙ and the respective fiber mode E_{μν},

$${η}_{μ v} = \frac{{\vert \int \int {E}_{in} {E}_{μ v}^{*} r d r d θ \vert}^{2}}{\int \int {\vert {E}_{in} \vert}^{2} r d r d θ \int \int {\vert {E}_{μ v} \vert}^{2} r d r d {θ}^{*}} \qquad Eq . ( 11 )$$

in polar coordinate. The symbol * in (11) denotes the complex conjugate. Equation (9) shows that the associated Laguerre polynomial (as the basic transverse mode set for graded-index fiber) can be expressed in the terms of Hermite polynomial. For this reason, to achieve selective mode group excitation, Hermite-Gaussian beams are used as a basic set for generating the launch field. The Hermite-Gaussian transverse electric field in polar coordinates is defined as:

$${E}_{mn} ( r , θ , κ ) = \frac{{2}^{( m + n - 2 ) / 2} \sqrt{κ}}{\sqrt{π} \sqrt{m ! n !}} {H}_{m} ( \sqrt{κ} r cos θ ) {H}_{n} ( \sqrt{κ} r sin θ ) exp ( - \frac{κ {r}^{2}}{2} ) \qquad Eq . ( 12 )$$

where w₀=\sqrt{2/κ}={square root over (a/(k₀n₁)}\sqrt{Δ}) is the waist of the fundamental mode in an ideal graded-index multimode fiber. A higher order Hermite-Gaussian mode (m>0) is considered in one direction; whereas a fundamental Gaussian mode (n=0) is assumed for the other. The resultant two-dimensional electric field distribution is, therefore, written as

$${E}_{m 0} ( r , θ , κ ) = \frac{{2}^{( m - 2 ) / 2} \sqrt{κ}}{\sqrt{π} \sqrt{m !}} {H}_{m} ( \sqrt{κ} r cos θ ) exp ( - \frac{κ {r}^{2}}{2} ) \qquad Eq . ( 13 )$$

For a given azimuthal order ν and radial order μ, a linearly polarized mode degenerates into four possible forms accounting two polarizations Eₓ, E_{y} and two orientations cos υθ, sin υθ. It is assumed that the coupling efficiency is independent of the state-of-polarization and that the MMF is radially symmetric. Hence, by taking the real part of Eq. (7) without loss of generality, the electric field of the guided transverse modes can be written as:

$${E}_{μ v} ( r , θ ) = {κ}^{\frac{2 v - 1}{4}} {r}^{v} exp ( - κ \frac{1}{2} {r}^{2} ) {L}_{μ}^{( v )} ( κ {r}^{2} ) cos ( v θ ) \qquad Eq . ( 14 )$$

By expressing the Hermite polynomials in terms of Laguerre polynomials, a Hermite-Gaussian beam in Eq. (12) may be expressed in terms of a set of Laguerre-Gaussian beam with the same mode group order,

$${E}_{mn} ( r , θ , κ ) = \frac{{2}^{( m + n + 2 ) / 2} \sqrt{m ! n !}}{\sqrt{π}} {{κ}^{\frac{3}{4}} ( - 1 )}^{\frac{n}{2}} \{ {\sum }_{k = 0}^{( m + n ) / 2} [ k ! {E}_{k , m + n - 2 k} ( r , θ ) {\sum }_{s = 0}^{k} {( - 1 )}^{s} \frac{1}{s ! ( m - s ) ! ( k - s ) ! ( n - k + s ) !} ] + {\sum }_{k = 0}^{( m + n ) / 2 - 1} [ ( \frac{m + n}{2} - k - 1 ) ! {E}_{\frac{m + n}{2} k - 1 , 2 k + 2} ( r , θ ) {\sum }_{s = 0}^{( m + n ) / 2 + k + 1} {( - 1 )}^{s} \frac{1}{s ! ( m - s ) ! ( \frac{m + n}{2} + k + 1 + s ) ! ( \frac{n - m}{2} - k - 1 - s ) !} ] \} \qquad Eq . ( 15 a )$$

for even m and n,

$${E}_{mn} ( r , θ , κ ) = \frac{{2}^{( m + n + 2 ) / 2} \sqrt{m ! n !}}{\sqrt{π}} {{κ}^{\frac{3}{4}} ( - 1 )}^{\frac{n}{2}} \{ {\sum }_{k = 0}^{( m + n - 1 ) / 2} [ k ! {E}_{k , m + n - 2 k} ( r , θ ) {\sum }_{s = 0}^{k} {( - 1 )}^{s} \frac{1}{s ! ( m - s ) ! ( k - s ) ! ( n - k + s ) !} ] - {\sum }_{k = 0}^{( m + n - 1 ) / 2} [ ( \frac{m + n - 1}{2} - k ) ! {E}_{\frac{m + n - 1}{2} k , 2 k + 1} ( r , θ ) {\sum }_{s = 0}^{( m + n - 1 ) / 2 + k + 1} {( - 1 )}^{s} \frac{1}{s ! ( m - s ) ! ( \frac{m + n - 1}{2} + k + 1 + s ) ! ( \frac{n - m + 1}{2} - k - 1 - s ) !} ] \} \qquad Eq . ( 15 b )$$

for odd m and even n,

$${E}_{mn} ( r , θ , κ ) = \frac{{2}^{( m + n + 2 ) / 2} \sqrt{m ! n !}}{\sqrt{π}} {{κ}^{\frac{3}{4}} ( - 1 )}^{\frac{n - 1}{2}} \{ {\sum }_{k = 0}^{( m + n - 1 ) / 2} [ k ! {E}_{k , m + n - 2 k}^{*} ( r , θ ) {\sum }_{s = 0}^{k} {( - 1 )}^{s} \frac{1}{s ! ( m - s ) ! ( k - s ) ! ( n - k + s ) !} ] + {\sum }_{k = 0}^{( m + n - 1 ) / 2} [ ( \frac{m + n - 1}{2} - k ) ! {E}_{\frac{m + n - 1}{2} k , 2 k + 1}^{*} ( r , θ ) {\sum }_{s = 0}^{( m + n - 1 ) / 2 + k + 1} {( - 1 )}^{s} \frac{1}{s ! ( m - s ) ! ( \frac{m + n - 1}{2} + k + 1 + s ) ! ( \frac{n - m + 1}{2} - k - 1 - s ) !} ] \} \qquad Eq . ( 15 c )$$

for even m and odd n,

$${E}_{mn} ( r , θ , κ ) = \frac{{2}^{( m + n + 2 ) / 2} \sqrt{m ! n !}}{\sqrt{π}} {{κ}^{\frac{3}{4}} ( - 1 )}^{\frac{n - 1}{2}} \{ {\sum }_{k = 0}^{( m + n ) / 2} [ k ! {E}_{k , m + n - 2 k}^{*} ( r , θ ) {\sum }_{s = 0}^{k} {( - 1 )}^{s} \frac{1}{s ! ( m - s ) ! ( k - s ) ! ( n - k + s ) !} ] - {\sum }_{k = 0}^{( m + n ) / 2 - 1} [ ( \frac{m + n}{2} - k - 1 ) ! {E}_{\frac{m + n}{2} k - 1 , 2 k + 2}^{*} ( r , θ ) {\sum }_{s = 0}^{( m + n ) / 2 + k + 1} {( - 1 )}^{s} \frac{1}{s ! ( m - s ) ! ( \frac{m + n}{2} + k + 1 + s ) ! ( \frac{n - m}{2} - k - 1 - s ) !} ] \} \qquad Eq . ( 15 d )$$

for odd m and n. In all cases, the mode group order of the guided transverse modes remains the same as m+n+1. Consequently, by setting the incident beam Eᵢₙ to a Hermite-Gaussian beam Eₘₙ, only those guided modes with the same mode group order as m+n+1 will have non-zero values in the overlap integral in Eq. (11) given the orthogonal property of the guided transverse modes. In other words, the excited mode group in a MMF is determined solely by the order of the incident Hermite-Gaussian beam. As different modes in a mode group propagate at a similar speed, this method of selectively exciting a target mode group effectively enables single-mode operation in a MMF, thereby providing an improved effective modal bandwidth that is near the ultimate transmission limit of the link.

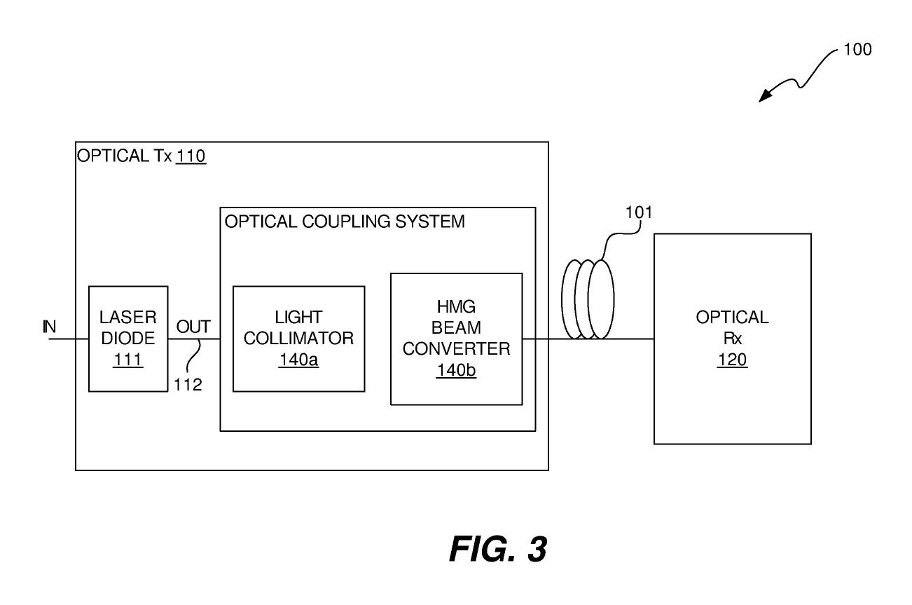

FIG. 3 illustrates a block diagram of an optical MMF link 100 that incorporates the methods and apparatuses of the invention in accordance with an illustrative, or exemplary, embodiment. The optical MMF link 100 includes a MMF 101, an optical transmitter or transceiver (Tx) 110 coupled to one end of the MMF 101, and an optical receiver or transceiver (Rx) 120 coupled to the opposite end of the MMF 101. For ease of illustration and the interest of brevity, only the components of the optical Tx 110 and Rx 120 that are needed to describe features of the invention are shown in FIG. 3. The optical Tx 110 includes a laser diode 111, a single mode optical fiber stub 112 connected on one end to the laser diode 111, and an optical coupling system 140 coupled to the opposite end of the single mode optical fiber stub 112. The optical coupling system 140 is coupled to one end of the MMF 101.

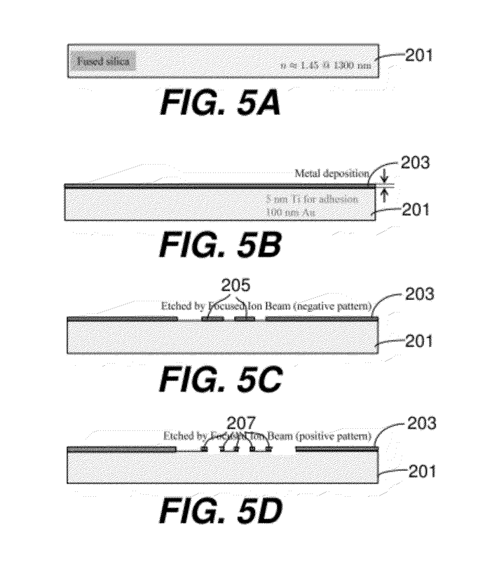

The laser diode 111 receives an electrical input signal, IN, which is typically an electrical data signal, and produces an optical output signal, OUT, which is typically an optical data signal. The optical signal OUT is coupled into the entrance facet of the single mode optical fiber stub 112. The optical signal OUT is then output from an exit facet of the stub 112 and coupled into the optical coupling system 140. The optical coupling system 140 includes a light collimator 140a, such as a collimating lens, and an HMG beam converter 140b, which may take on any one of a variety of forms, as will be described below in more detail. The light collimator 140a collimates the optical signal output from the exit facet of the stub 112. The HMG beam converter 140b receives the collimated light beam and converts the collimated light beam into a line of collimated spots such as that depicted in FIG. 2. The line of spots produced by the HMG beam converter 140b will vary depending on the HMG mode group that is targeted for excitation. The line of spots is launched by the HMG beam converter 140b into an entrance facet of the MMF 101 and causes one or more targeted HMG mode groups to be excited. Excitation of the targeted HMG mode group or groups causes the effective modal bandwidth of the optical MMF link 100 to be increased. The manner in which the HMG beam converter 140b may be configured will be described below with reference to FIGS. 5A-5D.

The aforementioned line of spots may be produced in a variety of ways. For example, the HMG line of spots may be generated by either a far-field approach using lenses and a holographic technique, or by near-field beam shaping using a single-to-multi-mode fiber coupling scenario of the type depicted in and described above with reference to FIG. 3. In the far-field approach, a pair of collimating lenses (not shown) and a phase mask (not shown) are used to process the optical signal output from the single-mode fiber stub (not shown), with the collimating lenses being disposed on opposite sides of the phase mask. The single-mode fiber stub output gives a diffraction-limited Gaussian beam, which is collimated to give a uniform phase front at some working distance where the mask is placed. Whilst retaining the Gaussian intensity profile, the phase profile is changed by the phase mask, and the far-field beam profile evolves to the desired complex beam profile. The collimating lens that follows the phase mask is used to magnify or de-magnify the beam to achieve the desired spot size. As a fixed output beam profile is required for different fibers of the same type, the same optics design can be applied to all fibers to minimise the complexity of the implementation. The phase mask, however, may require a complex design procedure, and may not be readily generated in a flexible manner that allows experimental tolerance to be assessed. Hence, while the far-field approach is suitable for use with the invention, the near-filed approach, of which FIG. 3 illustrates an exemplary or illustrative embodiment, may be more easily implemented with less complexity. Accordingly, the embodiments described hereinafter will assume that the near-field approach of FIG. 3 is used. It should also be noted, however, that the line of spots could be directly generated from the laser. For example, using a vertical cavity surface emitting laser diode (VCSEL), the aperture of the VCSEL could be shaped to produce the line of spots so that the line of spots produced by the VCSEL could be directly coupled into the entrance facet of the MMF or could be coupled by some type of optics system into the entrance facet of the MMF. Thus, the HMG beam converter referred to herein may be a separate component from the optics system, or part of the laser, or some other component external to the laser and the optics system.

With reference again to FIG. 3, in accordance with the near-field approach, the collimated Gaussian beam output from the light collimator 140a is shaped into an HMG beam comprising the line of spots (e.g., FIG. 2) by the HMG beam converter 140b, which may be a combined phase and intensity mask that is butt-coupled to an end facet of the MMF 101. In order to generate the HMG beam, the HMG beam converter 140b includes a mask (not shown) that is formed with greyscale intensity modulation values and binary phase modulation values. As will be described below in more detail, an exact HMG intensity profile for the mask is not required in order to obtain the line launch. For this reason, a binary intensity mask can be used to generate the HMG beam profile. This feature allows a relatively simple design to be used for the mask of the HMG beam converter 140b, which facilitates manufacturing of HMG beam converter 140b. It should be noted, however, that it is possible to generate HMG beams directly from multi-transverse-mode lasers. It has been shown that the higher-order transverse-modes of a laser can be selectively excited if the laser structure is designed appropriately. The output transverse-modes of lasers with rectangular geometry can be described by general-order HMG beams. Such multi-transverse-mode lasers, however, normally contain multiple spatial modes (i.e., different orders of HMG beams) that cannot be separated easily for individual use. This is particularly true for higher-order HMG modes. In addition, with current state-of-the-art technology, the multi-transverse-mode lasers cannot be directly modulated fast enough to meet the requirements for very high speed data communications applications. Hence, direct generation of a higher order HMG beams from a laser for high speed data communications applications will only become a feasible solution if these two limitations are overcome. Therefore, the principles and concepts of the invention will be described herein with reference to use of the HMG beam converter 140b shown in FIG. 3.

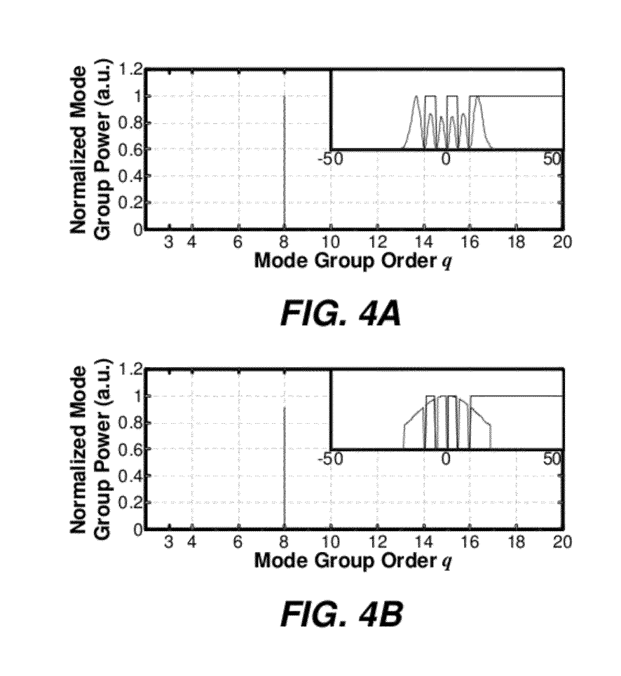

The manner in which the HMG beam converter 140b may be fabricated in accordance with an illustrative or exemplary embodiment is described with reference to FIGS. 5A-5D. Prior to describing the manner in which the HMG beam converter 140b may be fabricated, the reasons as to why it is satisfactory for the beam converter 140b to produce a binary intensity profile will first be described with reference to FIGS. 4A and 4B. FIG. 4A illustrates a mode group power distribution for an ideal HMG line launch, whereas FIG. 4B illustrates a mode group power distribution for a non-ideal HMG line launch produced by a binary mask of the beam converter 140b that produces a binary intensity profile. A binary intensity profile is preferred because it simplifies the fabrication process in that the binary mask of the beam converter 140B can be manufactured with a single etch depth compared with multiple etch depths that are needed for a mask that performs grayscale intensity modulation. It can be seen from a comparison of FIGS. 4A and 4B that with the same relative π phase difference between the adjacent spots, the mode group power extinction achieved in FIG. 4B by the binary mask of the beam converter 140b is nearly the same as that achieved by the ideal HMG line launch shown in FIG. 4A that would be achieved by a grayscale mask. This finding indicates that the phase profile of the launch beam is the prime parameter for a single mode group excitation, and explains the reason why a Gaussian centre launch, being the fundamental HMG mode with m=0, is less tolerant to the launch offset because of the lack of this phase profile.

In addition, a study of the tolerance to the differential phase difference and consequently the differential etch depth was also carried out for an OM1 fibre. In this study, an ideal line launch without launch offset was considered, and an extra phase term exp(iΔε) is added to Eq. (13). The calculated mode group power extinction degradation was plotted (not shown) for OM1 fibres. The degradation is defined as the difference in the mode group power extinction ratio from the ideal case of Δε=0. The results indicated that a phase error Δε of ±0.3π can be supported for a mode group power extinction ratio degradation smaller than 3 dB. This ±0.3π differential phase difference tolerance corresponds to an acceptable etch depth range of 450±150 nanometers (nm) in fused silica.

Typical laser sources for optical communications have a single transverse mode and are single-mode fiber-coupled, which yields an ideal Gaussian shape in the output beam profile. The generation of the HMG beam for the line launch implementation, therefore, becomes a problem of converting the input Gaussian beam into a HMG beam of a specific order in one direction whilst retaining the Gaussian profile in the other direction. A simple solution has been developed in accordance with embodiments of the invention to realize the proposed line launch by converting a Gaussian beam into the desired HMG beam profile so that the beam converter 140b, functioning as an intermediate connection between the optical Tx 110 and the fiber plant, MMF 101, can be used to achieve the line launch implementation of the type shown in FIG. 2. This feature allows a simple upgrade of the existing MMF links without the need of replacing the transceivers of the links.

FIGS. 5A-5D illustrate cross-sectional views of the HMG beam converter 140b shown in FIG. 3, which demonstrates the fabrication steps for fabricating an HMG beam converter 140b in accordance with an illustrative or exemplary embodiment. The process begins with a fused silica plate 201, as shown in FIG. 5A. The fused silica plate 201 is coated with a layer of ≈5 nm Titanium for adhesion on which a layer of approximately 100 nm of Gold is evaporated thereon. The coating of Titanium and the evaporated layer of Gold are represented by layer 203 in FIG. 5B. The combined phase and intensity mask is next fabricated using a two-step focused ion beam etching process. As shown in FIG. 5C, the first step forms a negative pattern 205 in a portion of the metal layer 203. As shown in FIG. 5D, the second step forms a positive pattern 207 in portions of the silica plate 201 that are unmasked by the negative pattern 205 shown in FIG. 5C. The positive pattern 207 is the binary phase and binary intensity pattern of the HMG beam converter 140b. Although focused ion beam etching is used for this purpose in accordance with the illustrative embodiment, the mask pattern could instead be formed by using conventional wet and/or dry etching processes. Focused ion beam etching provides certain advantages in that it allows rapid prototyping of the beam converter 140b without the need of preparing the shadow masks used in wet and dry etching processes. The use of focused ion beam etching also presents a unique advantage of nearly instant feedback to the designs. By precisely controlling the etch pattern and the etch depth, the required binary intensity mask and binary phase mask can be fabricated in two separate etch steps (FIGS. 5C and 5D). For a 1300 nm operating wavelength, a relative differential etch depth can be achieved that gives a relative π phase difference of 1300/1.45/2=448 nm, which is, in terms of practical precision, the limit of precision of focused ion beam etching to fused silica.

A experiment was conducted to demonstrate the principles and concepts of the overall line launch using the setup shown in FIG. 3 with the HMG beam converter 140b having the configuration described above with reference to FIGS. 5A-5D. In this experiment, 62.5 μm OM1 fiber was used as the MMF 101, but the principle of line launch is applicable for other types of graded-index multimode fibers as well (e.g. OM2 and OM3). The HMG beam converter 140b was back illuminated (the layer 201 is facing toward the end of the MMF 101 to which the beam converter 140b is coupled) with a magnified Gaussian spot from the light collimator 140a. The light collimator 140 a comprises a collimating lens that magnifies the output Gaussian beam from the single-mode fiber 112 to a required spot size at certain working distance. The magnified Gaussian spot had a full width at half maximum intensity width of ˜34 μm at ˜6.3 mm working distance from the lens. The pattern formed in the metal layer 201 in the step shown in FIG. 5D on the fused silica substrate 201 blocks the back illuminated light to give a Hermite-Gaussian-like binary intensity profile (as in FIG. 2), and the difference in the etch depth created in the step shown in FIG. 5D introduces the required relative π phase difference for the line launch. Under these settings (a 5^{th} order beam converter design and an ˜34 μm spot size), an insertion loss of ˜6.2 dB was incurred. This insertion loss can be reduced to ˜3.6 dB if an elliptical spot is used to illuminate the beam converter 140b instead of the circular spot that was used for the experiment.

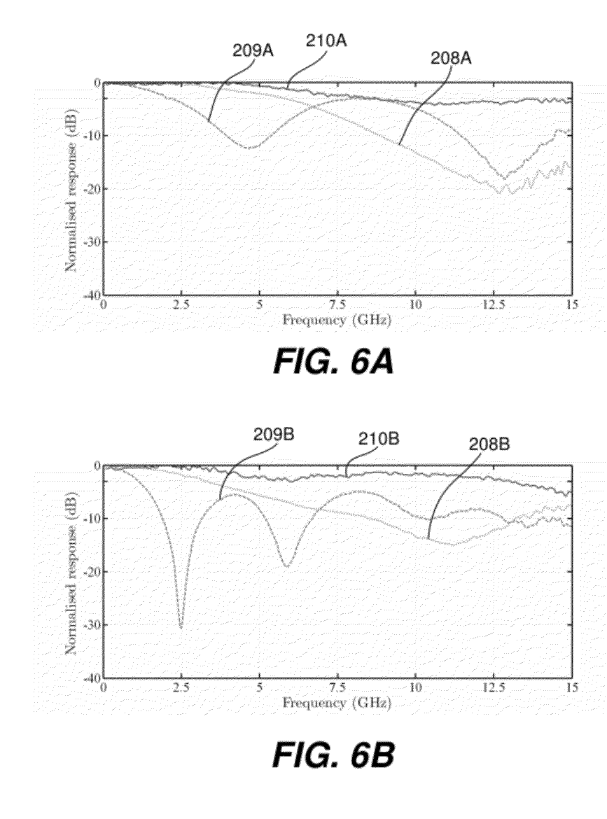

FIGS. 6A and 6B illustrate frequency responses for two different MMFs, fiber A and fiber B, for three different launch techniques: (1) the known center launch technique, which is represented by curves 208A and 208B in FIGS. 6A and 6B, respectively; (2) the known offset launch technique, which is represented by curves 209A and 209B in FIGS. 6A and 6B, respectively; and (3) the line launch technique of the invention, which is represented by curves 210A and 210B in FIGS. 6A and 6B, respectively. The line launches corresponding to curves 210A and 210B in FIGS. 6A and 6B allowed a 2.23 GHz·km and a 6.85 GHz·km, respectively, effective modal bandwidth-distance product to be achieved for fibers A and B, respectively. In contrast, for fiber A, the center and offset launches achieved effective modal bandwidth-distance products of 1.45 GHz·km and 0.52 GHz·km, respectively. For fiber B, the center and offset launches achieved effective modal bandwidth-distance products of 1.66 GHz·km and 0.57 GHz·km, respectively. Thus, the line launch of the invention achieved significantly greater effective modal bandwidth-distance product improvements over the known launch techniques for both types of MMFs. This effective modal bandwidth-distance product improvement is attributed to a near single mode group excitation achieved using the line launch technique.

Thus, it has been shown that the line launch technique of the invention takes advantage of one of the observations of the invention; in particular, that the phase profile of the launch beam is the most important parameter for high bandwidth operation. Consequently, an exact HMG intensity distribution is not required in the line launch implementation. Therefore, in accordance with the invention, a simple near-field approach has been developed to realize a practical line launch using a binary phase mask and a binary intensity mask, which are implemented in a single binary phase and intensity mask. The combined phase and intensity mask, which comprises the HMG beam converter 140B shown in FIG. 3, effectively implements the proposed line launch by turning an input Gaussian spot into an HMG-like beam. This combined binary phase and binary intensity mask provides a significant effective modal bandwidth improvement without offset.

The frequency responses for the case of the line launch are smooth over a wide frequency range. Measured results indicate a strong evidence for a single mode group excitation in which the excited mode group is determined by the order of the line launch. In addition, the measured frequency response under line launch remains smooth over the frequency range of interest even though the measured 3 dBo bandwidth drops as the launch offset increases. This unique characteristic can only be realised by the phase-modulated line launch of the invention and is not observed for centre launches or offset launches. In addition, the smooth frequency response associated with the line launch obviates the need to perform equalization in the optical Rx, or at the very least simplifies the complexity of electronic dispersion compensation circuits used at high bit rate operation. For example, the absence of deep nulls in the frequency response enables the use of simple zero forcing equalisers. Furthermore, the improvement in the effective modal bandwidth provided by the line launch technique enables the length of the optical MMF link to be substantially increased (e.g., three times as long) as that which may be achievable using centre and offset launch techniques.

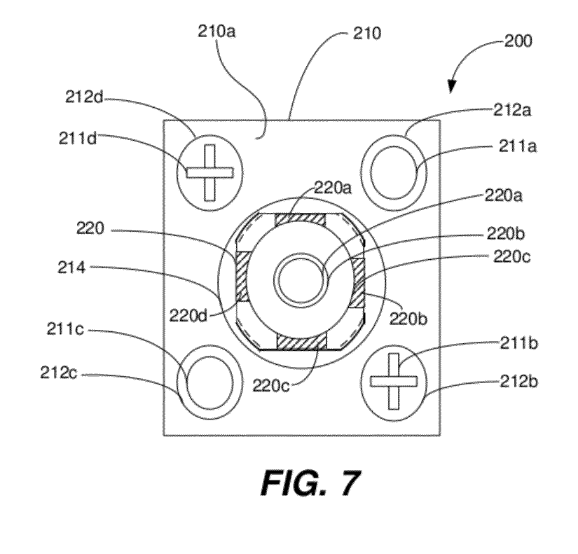

FIG. 7 illustrates a plan view of a multi-keyway optical fiber connector 200 in accordance with an illustrative or exemplary embodiment. The connector 200 has multiple keyways to enable the end of an optical fiber cable having a key thereon to be mated to the connector 200 in one of a plurality of radial positions that are radially offset from one another. As indicated above, an optical link that uses the line launch of the invention to excite HMG mode groups is less susceptible to connector offsets than other types of launch techniques. However, in order to further reduce the susceptibility of the launch to connector offsets, the multi-keyway connector 200 may be used to reduce or eliminate connector offsets. In accordance with this embodiment, the connector 200 is capable of connecting to an end of an optical fiber cable (not shown) in any one of four different radial positions of the end of the cable, as will be described below in more detail.

The connector 200 has a body 210 having a front face plate 210a and a back face plate (not shown), which are identical in construction. The connector 200 is similar in construction to a conventional fiber connector/physical contact (FC/PC) square adapter except that the connector 200 has multiple keyways, as described above, whereas the conventional FC/PC adapter has a single keyway and is only connectable to an end of an optical fiber cable in a single position. In the interest of brevity and for ease of illustration, only the front face plate 210a is illustrated in the drawings and described herein, as the back face plate (not shown) is substantially identical in construction to the front face plate 210a.

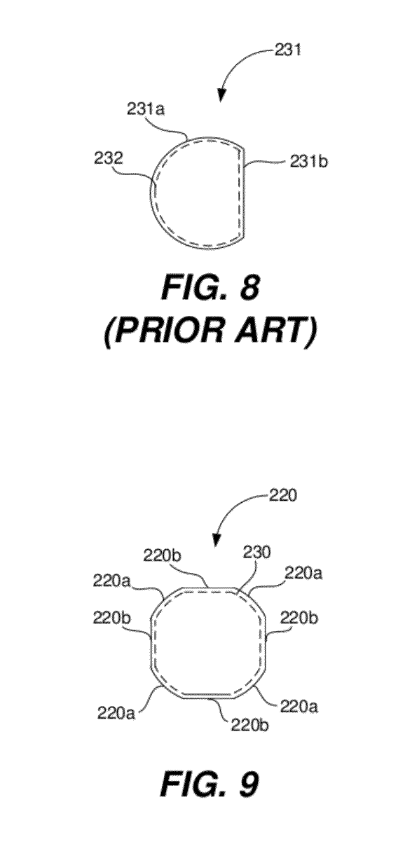

The front face plate 210a and the back face plate (not shown) are connected together via fastening devices 211a-211d that mate with threaded holes 212a-212d, respectively, formed in the face plates. The front face plate 210a has inner connector portions 213a, 213b and 213c formed thereon and an outer connector portion 214 formed thereon, which come into contact with respective connector portions (not shown) disposed on the end of the optical fiber cable (not shown) that couples to the connector 200. In accordance with this embodiment, the components 210a, 211a-211d, 212a-212d, and 214 are identical to the corresponding components of a conventional FC/PC square adapter. The term “square” is used in the industry to denote that the face plates are generally square in shape, resulting in the shape of the adapter being generally square in shape. The connector 200, however, also includes a multi-way keyway component 220 that provides multiple keyways 220a-220d as compared to the corresponding keyway component of the conventional FC/PC square adapter, which provides a single keyway, as will now be described with reference to FIGS. 8 and 9.

FIG. 8 illustrates a plan view of the keyway component 231 of a conventional, or standard, FC/PC square adapter. The keyway component 231 has a first portion 231a that is generally cylindrical in shape and a second portion 231b that is generally flat, or planar. In other words, the keyway component 231 is generally a cylinder having a flat portion. The key component on the conventional optical fiber cable, which is represented by the dashed outline 232, has the same shape as that of the keyway component 231, but is slightly smaller in size than the keyway component 231. When the cable (not shown) is coupled to the connector 200, the keyway and key components 231 and 232 are in abutment, as shown, and the matching shapes prevent rotational movement of the key component 232 within the keyway component 231. Thus, the key component 232 can only be inserted into the keyway component 231 in the position shown in FIG. 8. If, however, the cables connected to each side of the adapter are not in optical alignment when their respective key components are contained within their respective keyway component, the respective fiber cores will be misaligned by some amount, which results in the aforementioned connector offset. This connector offset can cause mode power to be spread into other mode groups resulting in a larger modal dispersion effect, a smaller operating bandwidth, and a lower data rate.

FIG. 9 illustrates a plan view of the keyway component 220 of the connector 200 shown in FIG. 7. The dashed outline 230 represents the keyway component of the optical fiber cable (not shown) that attaches to the connector 200. The keyway component 220 has multiple cylindrical portions 220a and multiple flat portions 220b. The key component 230 has the same shape as that of the keyway component 220, but is slightly smaller in size than the keyway component 220. In this illustrative embodiment, the keyway component 220 has four cylindrical portions 220a and four flat portions 220b. Each cylindrical portion 220a is spaced apart from its nearest cylindrical portions 220a by 90°. Likewise, each flat portion 220b is spaced apart from its nearest flat portions 220b by 90°. The flat portions 220b are located in between cylindrical portions 220a. Thus, the key component 230 is capable of interlocking with the keyway component 220 in any one of the four interlocking positions. This feature allows a user to connect the cable (not shown) to the connector 200 in each of the four positions and perform a test to determine which of the four positions results in the least amount of connector offset, and thus the best signal integrity.

It should be noted that although a four-way connector 200 has been described herein, the principles and concepts of the invention apply to any multi-way connector configuration. For example, instead of having four cylindrical portions 220a and four flat portions 220b, the keyway component may have eight cylindrical portions 220a and eight flat portions 220b, in which case each cylindrical portion 220a would be separated from its nearest neighbouring cylindrical portions 220a by 45°. In the latter case, a cable could be connected to the connector 200 in any one of eight radial positions. As another example, instead of having four cylindrical portions 220a and four flat portions 220b, the keyway component may have two cylindrical portions 220a and two flat portions 220b, in which case each cylindrical portion 220a would be separated from its nearest neighbouring cylindrical portions 220a by 180°. In the latter case, a cable could be connected to the connector 200 in either one of two radial positions.

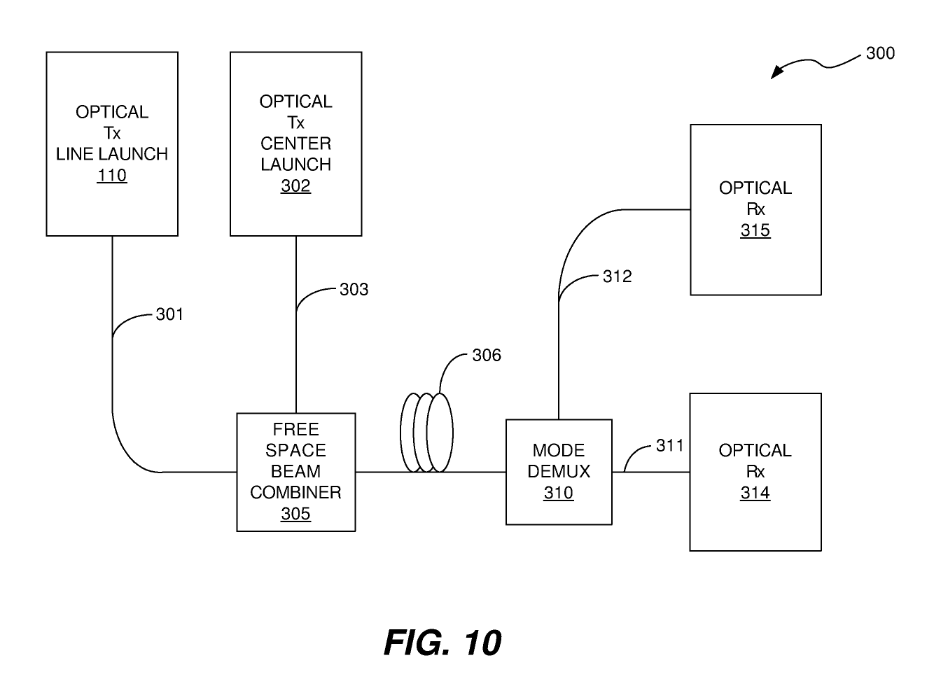

FIG. 10 illustrates a block diagram of an optical link 300 in accordance with another illustrative embodiment of the invention in which the line launch technique of the invention is used in combination with the aforementioned known center launch technique. In accordance with this embodiment, mode group multiplexing (MUXing) and demultiplexing (DeMuxing) is performed. The Tx 110 shown in FIG. 3, or one similar thereto, is used to perform the line launch of the invention described above to cause one or more higher order HMG mode groups to be excited in a first MMF 301. The Tx 302 is a known Tx that performs a known center launch technique to cause one or more lower order mode groups to be excited in a second MMF 303. A known optical free space beam combiner 305 combines the optical signals being carried on the MMFs 301 and 303 and couples them into an end facet of a link MMF 306. The optical signals propagate along the link MMF 306 and are received in a mode group demultiplexer (DeMux) 310. The mode group DeMux 310 demultiplexes the higher order and lower order mode groups to separate the higher order mode groups from the lower order mode groups. The mode group DeMux 310 then couples the optical signals containing the lower order mode groups onto optical fiber 311 and the optical signals containing the higher order mode groups onto optical fiber 312. The optical signals carried on optical fiber 311 are received by optical Rx 314 and the optical signals carried on optical fiber 312 are received by optical Rx 315. The optical Rx 314 and the optical Rx 315 may be known optical receivers having known configurations. The optical Rx 314 may incorporate an electronic dispersion compensation (EDC) device to compensate for mode dispersion resulting from use of the center launch technique. The optical RX 314 does not need an EDC device due to the fact that the line launch technique of the invention sufficiently reduces mode dispersion.

The arrangement of the optical link 300 enables higher bandwidths and longer link lengths to be achieved due to the reduced modal dispersion caused by exciting only targeted mode groups. For example, each optical channel may have a bandwidth of 10 Gb/s, thereby resulting in an overall link bandwidth of 20 Gb/s. The length of the link MMF 306 can be at least about 220 meters (m) for OM1 MMF fiber, for example.

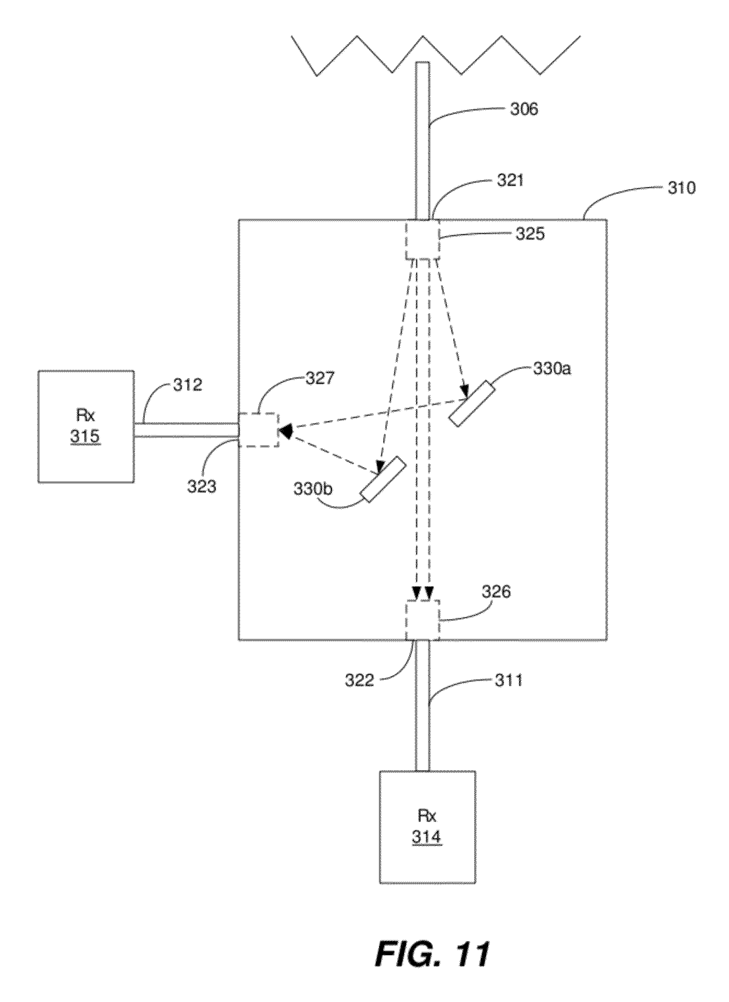

FIG. 11 illustrates a plan view of the mode group DeMux 310 shown in FIG. 10. The mode group DeMux 310 includes a first input port 321 and first and second output ports 322 and 323. The ends of the fibers 306, 311 and 312 have connectors 325, 326 and 327, respectively, thereon that are coupled to respective mating receptacles (not shown) of the ports 321, 322 and 323, respectively.

Most of the optical energy associated with the lower order mode groups remains generally coaxial with the optical axis of the MMF 306 than that associated with the higher order mode groups as the optical energy propagates through free space inside of the mode group DeMux 310. Therefore, the optical energy associated with the lower order mode groups simply propagates from the connector 325 to the connector 326. From the connector 326, the optical energy associated with the lower order mode groups is coupled into the fiber 311 and propagates along the fiber 311 to the optical Rx 314 where it is received. The optical energy associated with the higher order mode groups propagates in directions that are at greater angles to the optical axis of the MMF 306. Optical elements 330a and 330b that are partially or wholly reflective are positioned to receive the optical signals associated with the higher order mode groups and to direct the optical signals toward the connector 327. The connector 327 couples the optical signals into the fiber 312, which carries the signals to the optical Rx 315.

It should be noted that the configuration of the mode group Demux 310 shown in FIG. 11 is only one of many possible configurations that may be used to perform the mode group demuxing tasks. Those skilled in the art will understand the manner in which the configuration shown in FIG. 11 may be altered while still performing the demuxing tasks. It should also be noted that, because the spatial mode muxing and demuxing operations described above with reference to FIGS. 10 and 11 are orthogonal to other types of muxing demuxing operations (e.g., wavelength division multiplexing (WDM), code division multiple access (CDMA), polarisation multiplexing, etc.), one or more of these other muxing/demuxing types may be used in conjunction with the spatial mode muxing/demuxing operations described above with reference to FIGS. 10 and 11. Persons of ordinary skill in the art will understand the manner in which these other muxing/demuxing types can be combined with the spatial mode multiplexing technique described above with reference to FIGS. 10 and 11.

The invention has been described with reference to preferred or illustrative embodiments for the purposes of demonstrating the principles and concepts of the invention. Those skilled in the art, however, will understand that the invention is not limited to these demonstrative embodiments. A variety of modifications can be made to the embodiments described above without deviating from the scope of the invention.

What is claimed is:

1. An apparatus for use in an optical communications link for providing a line launch of light into an end facet of a link multi-mode fiber (MMF), the apparatus comprising:
a laser that produces laser light; and
an optics system that receives the laser light, the optics system including:
a Hermite-Gaussian (HMG) beam converter that receives the laser light and converts the laser light into a line of HMG spots, and wherein the line of HMG spots comprises multiple HMG spots that are positioned along a line that is generally orthogonal to an optical axis of the link MMF.

2. The apparatus of claim 1, wherein the apparatus is part of an optical transmitter (Tx) that is coupled to the end facet of the link MMF, and wherein the line of HMG spots produced by the HMG beam converter are launched into the end facet of the link MMF to cause at least one targeted higher order mode group to be excited in the link MMF, and wherein excitation of said at least one targeted HMG mode group reduces modal dispersion in the link MMF and allows a bandwidth of the link MMF to be increased.

3. The apparatus of claim 2, wherein the optical Tx is part of an optical transceiver module, and wherein the optical transceiver module is coupled to the end facet of the link MMF.

4. The apparatus of claim 2, further comprising:
a single mode fiber stub having a first end facet and a second end facet, the first end facet of the stub being positioned to receive the laser light produced by the laser, the second end facet of the stub being optically coupled to the optics system such that laser light propagating in the stub passes out of the second end facet of the stub into the optics system.

5. The apparatus of claim 4, wherein the optical coupling system further comprises:
a light collimator that receives light passing out of the second end facet of the stub and collimates the light to produce a collimated beam of light, and wherein the HMG beam converter is positioned with respect to the light collimator to receive the collimated light beam and to convert the collimated light beam into the line of HMG spots.

6. The apparatus of claim 5, wherein the HMG beam converter comprises:
a binary intensity mask comprising binary intensity modulation values and binary phase modulation values, and wherein the binary intensity mask converts the collimated light beam into the line of HMG spots.

7. The apparatus of claim 6, wherein the binary intensity modulation values are greyscale values.

8. The apparatus of claim 6, wherein the binary intensity mask comprises a surface having height variations corresponding to the binary intensity and phase modulation values.

9. An optical communications link comprising:
at least a first optical transmitter (Tx) coupled to a first end facet of a link multi-mode fiber (MMF), the first optical Tx comprising:
a laser that produces laser light; and
an optics system that receives the laser light, the optics system including:
a Hermite-Gaussian (HMG) beam converter that receives the laser light and converts the laser light into a line of HMG spots, and wherein the line of HMG spots comprises multiple HMG spots that are positioned along a line that is generally orthogonal to an optical axis of the link MMF;
and
at least a first optical receiver (Rx) coupled to a second end facet of the link MMF.

10. The optical communications link of claim 1, wherein the line of HMG spots produced by the HMG beam converter are launched into the first end facet of the link MMF to cause at least one targeted higher order mode group to be excited in the link MMF, and wherein excitation of said at least one targeted HMG mode group reduces modal dispersion in the link MMF and allows a bandwidth of the link MMF to be increased.

11. The optical communications link of claim 10, wherein the optical Tx is part of an optical transceiver module, and wherein the optical transceiver module is couple to the end facet of the link MMF.

12. The optical communications link of claim 2, further comprising:
a single mode fiber stub having a first end facet and a second end facet, the first end facet of the stub being positioned to receive the laser light produced by the laser, the second end facet of the stub being optically coupled to the optics system such that laser light propagating in the stub passes out of the second end facet of the stub into the optics system.

13. The optical communications link of claim 12, wherein the optics system further comprises:
a light collimator that receives light passing out of the second end facet of the stub and collimates the light to produce a collimated beam of light, and wherein the HMG beam converter is positioned with respect to the light collimator to receive the collimated light beam and to convert the collimated light beam into the line of HMG spots.

14. The optical communications link of claim 13, wherein the HMG beam converter comprises:
a binary intensity mask comprising binary intensity modulation values and binary phase modulation values, and wherein the binary intensity mask converts the collimated light beam into the line of HMG spots.

15. The optical communications link of claim 14, wherein the binary intensity modulation values are greyscale values.

16. The optical communications link of claim 14, wherein the binary intensity mask comprises a surface having height variations corresponding to the binary intensity and phase modulation values.

17. An optical communications link comprising:
a link multi-mode fiber (MMF) having a first end facet and a second end facet;
an optical beam combiner for combining laser light produced by multiple laser diodes, the beam combiner having at least first and second input ports and an output port, the output port being optically coupled to the first end facet of the link MMF;
at least a first optical transmitter (Tx) coupled to the first input port of the beam combiner, the first optical Tx comprising:
a first laser that produces laser light; and
an optics system that receives the laser light and performs a line launch technique, the optics system including:
a Hermite-Gaussian (HMG) beam converter that receives the laser light and converts the laser light into a first optical signal comprising a line of HMG spots, and wherein the line of HMG spots comprises multiple HMG spots that are positioned along a line that is generally orthogonal to an optical axis of the link MMF, and wherein the first optical signal is optically coupled into the beam combiner via the first input port of the beam combiner;
at least a second optical Tx coupled to the second input port of the beam combiner, the second optical Tx comprising:
a second laser that produces laser light; and
an optics system that receives the laser light produced by the second laser and performs a center launch technique, the optics system of the second optical Tx comprising one or more optical elements that convert the laser light produced by the second laser into a second optical signal, and wherein the second optical signal is optically coupled into the beam combiner via the second input port of the beam combiner, and wherein the beam combiner combines the first and second optical signals to produce a third optical signal, the beam combiner coupling the third optical signal into the first end facet of the link MMF to cause at least one targeted higher order HMG mode group and at least one lower order Laguerre Gaussian (LG) mode group to be excited in the link MMF;
a mode group demultiplexer (DeMux) coupled to the second end facet of the link MMF, the DeMux having a first input port and at least first and second output ports, the DeMux demultiplexing the third optical signal to separate said at least one targeted higher order HMG mode group from said at least one targeted lower order HMG mode group to form fourth and fifth optical signals, respectively, the DeMux outputting the fourth optical signal via the first output port of the DeMux and outputting the fifth optical signal via the second output port of the DeMux;
at least a first optical receiver (Rx) coupled to the first output port of the DeMux for receiving the fourth optical signal; and
at least a second optical Rx coupled to the second output port of the DeMux for receiving the fifth optical signal.

18. The optical communications link of claim 17, wherein the optical beam combiner further comprises at least a third input port, and wherein the optical communications link further comprises:
at least a third optical Tx coupled to the third input port of the beam combiner, the third optical Tx comprising:
a third laser that produces laser light that is multiplexed in accordance with one of a wavelength division multiplexing (WDM) technique, a code division multiple access (CDMA) multiplexing technique, and a polarisation multiplexing technique; and
an optics system that receives the laser light produced by the third laser and converts the laser light produced by the third laser into a sixth optical signal, and wherein the sixth optical signal is optically coupled into the beam combiner via the third input port of the beam combiner, and wherein the beam combiner combines the first, second and sixth optical signals to produce said third optical signal that is coupled by the beam combiner into the first end facet of the link MMF, and wherein the DeMux includes a third output port, the DeMux demultiplexing the third optical signal to separate the first, second and sixth optical signal from one another to form the fourth optical signal, the fifth optical signal and a seventh optical signal, respectively, the DeMux outputting the seventh optical signal via the third output port of the DeMux;
and
at least a third optical Rx coupled to the third output port of the DeMux for receiving the seventh optical signal.

19. A method for use in an optical communications link for providing a line launch of light into an end facet of a multi-mode fiber (MMF), the method comprising:
with a laser, producing laser light; and
in an optics system:
receiving the laser light, and
with a Hermite-Gaussian (HMG) beam converter of the optics system, receiving the laser light and converting the received laser light into a line of HMG spots; and
with a MMF optically coupled to the optics system, receiving the line of spots at an entrance facet of the MMF to cause at least one HMG mode group of the MMF to be selectively excited.

20. The method of claim 19, wherein the method is performed by an optical transmitter (Tx) that is coupled to the end facet of the link MMF, and wherein the line of HMG spots produced by the HMG beam converter are launched into the end facet of the link MMF to cause at least one targeted higher order mode group to be excited in the link MMF, and wherein excitation of said at least one targeted HMG mode group reduces modal dispersion in the link MMF and allows a bandwidth of the link MMF to be increased.

21. The method of claim 19, wherein the optical Tx is part of an optical transceiver module, and wherein the optical transceiver module is coupled to the end facet of the link MMF.

22. The method of claim 20, further comprising:
a single mode fiber stub having a first end facet and a second end facet, the first end facet of the stub being positioned to receive the laser light produced by the laser, the second end facet of the stub being optically coupled to the optics system such that laser light propagating in the stub passes out of the second end facet of the stub into the optics system.

23. The method of claim 22, wherein the optics system further comprises:
a light collimator that receives light passing out of the second end facet of the stub and collimates the light to produce a collimated beam of light, and wherein the HMG beam converter is positioned with respect to the light collimator to receive the collimated light beam and to convert the collimated light beam into the line of HMG spots.

24. The method of claim 23, wherein the HMG beam converter comprises:
a binary intensity mask comprising binary intensity modulation values and binary phase modulation values, and wherein the binary intensity mask converts the collimated light beam into the line of HMG spots.

25. The method of claim 24, wherein the binary intensity modulation values are greyscale values.

26. The method of claim 25, wherein the binary intensity mask comprises a surface having height variations corresponding to the binary intensity and phase modulation values.

27. A multi-way optical connector comprising:
an N-way keyway device having N identical keyways, where N is an integer that is greater than or equal to 2, the N-way keyway device being configured to mate with a key formed on an optical cable in any one of N radial positions relative to an optical axis of the multi-way optical connector.

28. The multi-way optical connector of claim 27, wherein the connector is a fiber connector/physical contact (FC/PC) square adapter.

29. The multi-way optical connector of claim 27, wherein N is equal to or greater than 4.
